(19) United States
(12) Patent Application Publication
(10) Pub. No.: US 2015/0008077 A1
(43) Pub. Date: Jan. 8, 2015

(54) PORTABLE ADJUSTABLE A-FRAME DOLLY DRYWALL CART STOP

(71) Applicant: Paul Anthony Nicosia, New York, NY (US)

(72) Inventor: Paul Anthony Nicosia, New York, NY (US)

(21) Appl. No.: 13/935,317

(22) Filed: Jul. 3, 2013

(51) Int. Cl. B60T 3/00

(52) U.S. Cl. CPC B60T 3/00
USPC 188/32

(57) ABSTRACT

A device that prevents an A-frame dolly drywall cart from rolling away from the operator during loading or unloading that is capable of adjusting to various wheel spans in order to accommodate a wide variety of drywall cart models. The device may be stored on the backside of the drywall cart in a position that would otherwise not be used for storage, thus enabling the device to travel with the drywall cart if desired without taking up storage space.

### BACKGROUND OF THE INVENTION

Operators prevent existing A-frame dolly drywall carts from rolling away from them during loading or unloading: (i) by having a second operator stand behind the cart while it is being loaded or unloaded; or (ii) by positioning scrap pieces of drywall, wood, or other material behind the cart.

Because of the repetition of the drywall cart loading and unloading process on a job site, operators often get careless and assume that a second operator is present and holding the drywall cart in place. Damage to property, reduced job site efficiency, and serious injury or death may result if an operator continues loading or unloading the cart after a second operator lets go of the cart. First, the loading/unloading operators may have to overextend themselves to reach the drywall cart as it slides away causing serious injuries. Second, the drywall cart can gain momentum as it slides away and tip over when it meets an obstruction (e.g., a pebble or a screw) causing serious injury or death. Third, the drywall cart can roll off of the platform upon which it is being loaded/unloaded (e.g., a trailer or loading dock) causing serious injury or death.

Workers who prevent the drywall cart from rolling away by positioning scrap materials behind it must not only stop work to find the pieces but must also constantly stop work to reposition the materials as they move or break apart. A further downside to using scrap materials to prevent a drywall cart from moving is that broken scrap materials may pose tripping hazards for operators and tipping hazards for drywall carts.

### SUMMARY OF THE INVENTION

An object of the present invention is to provide a device capable of preventing an A-frame dolly drywall cart from rolling away during loading and unloading that is: (i) capable of adjusting to various wheel spans in order to accommodate a wide variety of A-frame dolly drywall cart models; and (ii) may be stored on the backside of the drywall cart in a position that would otherwise not be used for storage, thus enabling the device to travel with the drywall cart if desired without taking up any storage space.

In accordance with a preferred embodiment of the invention the device includes two interlocking assemblies, a first assembly and a second assembly. Both the first and second assemblies comprise an elongated box with a tongue extending from one end and a cavity inside for receiving the counterpart assembly's tongue. In certain embodiments of the present invention, each box has a plate with a beveled edge running along its front side, which is flush with the base of the box. Each box also has two prong plates extending from the opposite end creating a fork which may engage a vertical frame member of a drywall cart while the device is travelling with the drywall cart. The device, however, may attach to the drywall cart by any other means of attachment. In certain embodiments, the prong plates have through-holes so that they may be hung on a wall for shop storage or so that they may be locked up via a lock and chain. A handle sits proud atop the box. The tongues have evenly spaced through-holes running vertically down the center of its length. These through-holes match up to evenly spaced through-holes on the counterpart assembly's tongue. The first assembly has a cavity directly below its tongue and the second assembly has a cavity directly above its tongue so that each assembly's tongue may be slidably received by the other assembly's cavity. The two assemblies may be interlocked using one or more sets of nuts and bolts, cotter pins, or any other means of maintaining the device's interconnection.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is an exploded perspective view of a portable adjustable A-Frame Dolly Drywall Cart Stop according to the present invention;

FIG. 2 is a perspective view of one of the tongues of a Portable Adjustable A-Frame Dolly Drywall Cart Stop according to the present invention;

FIG. 3 is a perspective view of a Portable Adjustable A-Frame Dolly Drywall Cart Stop according to the present invention shown stored on the backside of an A-Frame Dolly Drywall cart;

FIG. 4 is a perspective view of a Portable Adjustable A-Frame Dolly Drywall Cart Stop according to the present invention being used to prevent an A-Frame Dolly Drywall Cart from rolling; and

FIG. 5 is a perspective view of another embodiment of a Portable Adjustable A-Frame Dolly Drywall Cart Stop according to the present invention.

### DETAILED DESCRIPTION OF THE INVENTION

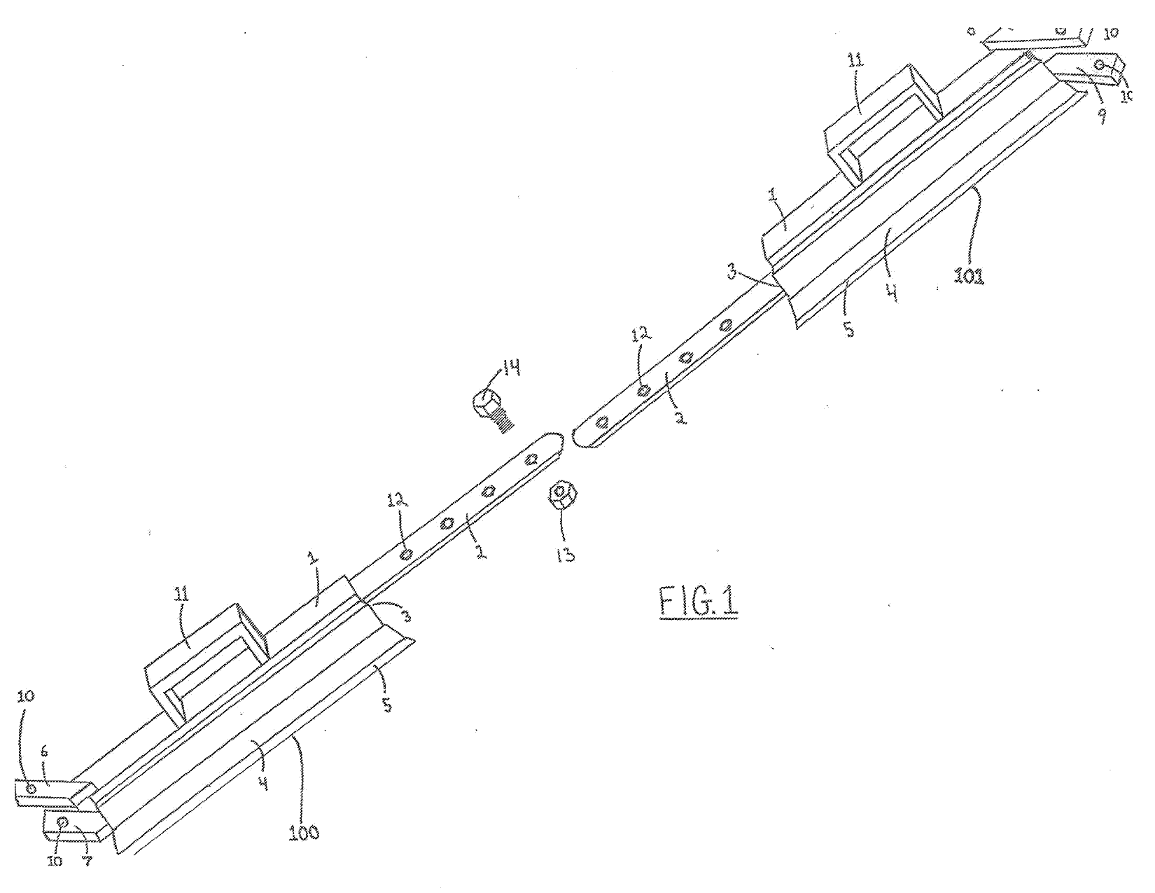

FIG. 1 depicts one embodiment of a device according to the present invention capable of preventing an A-frame dolly drywall cart from rolling away from the operator during loading and unloading or when a person is working off of it. The device includes two interlocking assemblies (100, 101) each comprised of an elongated box (1) with a tongue (2) extending from one end and a cavity (3) inside the elongated box for receiving the matching assembly's tongue (2). The box (1) also has a plate (4) with a beveled edge (5) running along the front side of said plate (4). The plate (4) is flush with the base of the box (1).

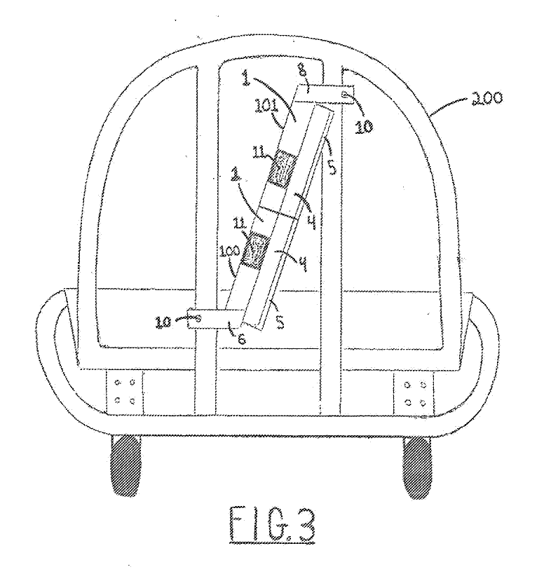

The elongated box (1) of the first assembly (100) has two prong plates (6, 7) extending from the opposite end creating a fork (6, 7) which is intended to be engaged to its corresponding vertical frame member of the drywall cart while the device is stored on or travelling with the drywall cart (see FIG. 3). The fork (6, 7) on the first assembly (100) is angled away from the length of the assembly in one direction while the fork (8, 9) on the second assembly (101) is angled away from the length of the assembly in the opposite direction. The device, however, may attach to the drywall cart by any other means of attachment known to those of skill in the art.

All prong plates (6, 7, 8, 9) have through-holes (10) so that they may be hung on a wall for shop storage or so that they may be locked up via a lock and chain or any other locking mechanism.

In certain embodiments, a handle (11) sits proud atop the elongated box (1).

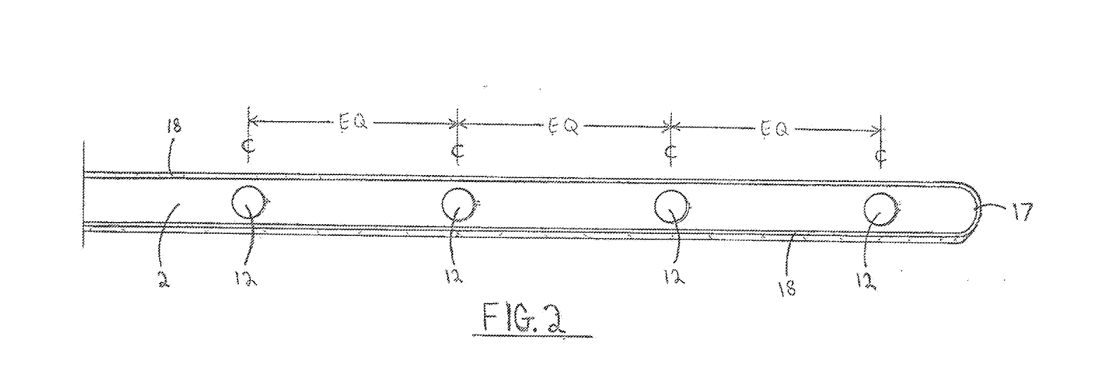

The tongue (2) has evenly spaced through-holes (12) running vertically down the center of its length (See FIG. 2). These through-holes (12) match up to evenly spaced through-holes (12) on the corresponding assembly's tongue (2). The first assembly (100) has a cavity (3) directly below its tongue (2) and the second assembly (101) has a cavity (3) directly above its tongue (2) so that each assembly's tongue (2) may be slidably received by the other assembly's cavity (3) when the two assemblies (100, 101) are joined. The two assemblies may be interlocked using one or more sets of nuts (13) and bolts (14), cotter pins, or any other method known to those of skill in the art for maintaining the device's interconnection.

FIG. 2 depicts a tongue (2). The tongue (2) has a bull nose (17) and chamfered edges (18) to reduce friction when the tongue (2) is slidably received by its corresponding assembly's cavity (3).

FIG. 3 depicts an embodiment of the present invention stored on the backside of a typical drywall cart (200).

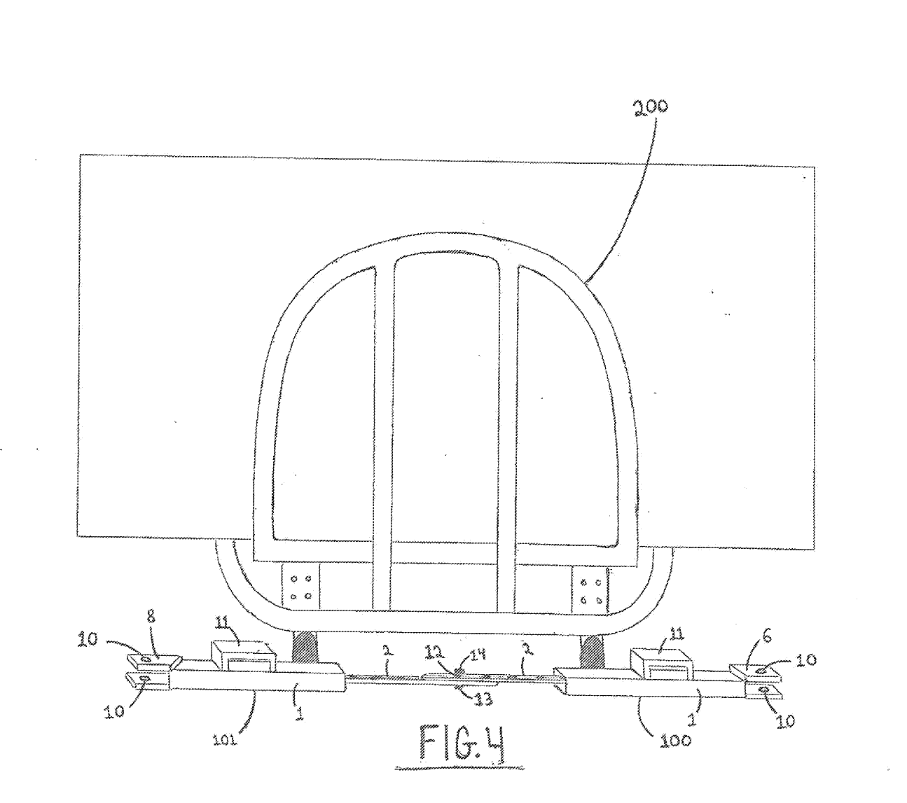

FIG. 4 depicts an embodiment of the present invention engaged with the wheels of a typical drywall cart (200).

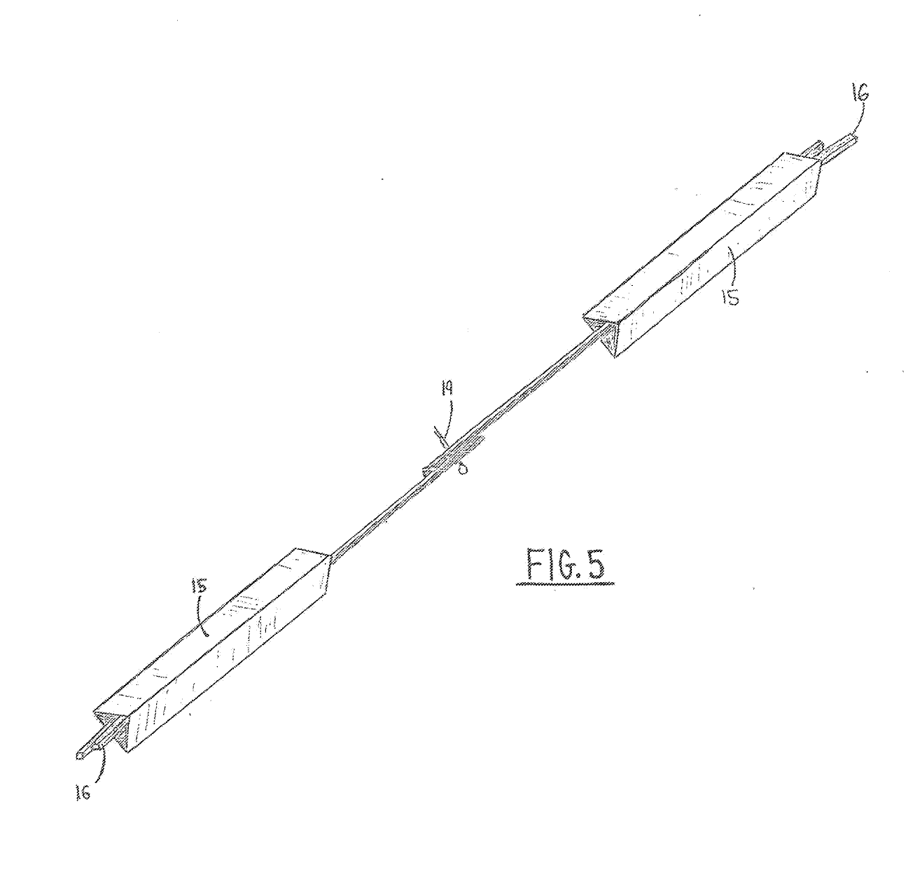

FIG. 5 depicts an alternative embodiment of the present invention with a triangular body (15). This alternative embodiment also has forks that have prong plates (16) that are offset to the top of the body so that they may double as handles.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A device for preventing an A-frame dolly drywall cart from rolling away from the operator comprising:
a) a first assembly comprising an elongated box with a tongue extending from one end of the first assembly and a cavity inside the elongated box for slidably receiving a second assembly's tongue, said first assembly's elongated box having a plate flush with the base of the box, said first assembly's tongue having evenly spaced through-holes running vertically down the center of the tongue's length; and
b) a second assembly comprising an elongated box with a tongue extending from one end of the second assembly and a cavity inside the elongated box for slidably receiving the first assembly's tongue, said second assembly's elongated box having a plate flush with the base of the box, said second assembly's tongue having evenly spaced through-holes running vertically down the center of the tongue's length;
c) means for attaching the tongues of the first and second assemblies; and
d) means for attaching the device to the vertical frame members of a drywall cart.

2. The device of claim 1, wherein the plate flush with the base of the elongated box of the first assembly and the plate flush with the base of the elongated box of the second assembly have beveled edges running along the front side of the plates.

3. The device of claim 1, wherein the elongated box of the first assembly and the elongated box of the second assembly have two prong plates that create a fork extending from the end opposite the tongues of the first and second assemblies, wherein the fork on the first assembly is angled away from the length of the assembly in one direction while the fork on the second assembly is angled away from the length of the assembly in the opposite direction.

4. The device of claim 3, wherein the prong plates have through-holes.

5. The device of claim 1, wherein a handle sits proud atop the elongated box of the first assembly and the elongated box of the second assembly.

6. The device of claim 1, wherein the means for attaching the tongues of the first and second assemblies when the first and second assemblies are joined comprise one or more sets of nuts and bolts or cotter pins.

7. The device of claim 1, wherein the tongues of the first and second assemblies have a bull nose and chamfered edges to reduce friction when each tongue is slidably received by its corresponding assembly's cavity.

8. The device of claim 1, wherein the elongated box of the first assembly and the elongated box of the second assembly is in the shape of a triangular prism.
